(19) United States
(12) Patent Application Publication
(10) Pub. No.: US 2008/0010108 A1
(43) Pub. Date: Jan. 10, 2008

(54) Market Research Analysis Method

(76) Inventors: Ken Roberts, Ascot Vale (AU); Carissa Wong, Lower Templestowe (AU); Elaine Wong, Melbourne (AU); Alan Simpson, Elwood (AU)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/753,838

(22) Filed: May 25, 2007

(30) Foreign Application Priority Data
May 30, 2006 (AU) 2006202302

(51) Int. Cl. G06F 17/30

(52) U.S. Cl. 705/10

(57) ABSTRACT

A method is provided of predicting changes in market share, in the form of Preference Shares, in a market associated with proposed performance changes. The initial step is to provide a set of market research data suitable for CVA, including current market share data. The next step is to perform a CVA analysis through regression analysis in order to determine WWP parameters, so that for the market as a whole, a set of coefficients determining relative importance of each value driver to WWP, and for each market participant, a set of performance scores for each value driver, and an overall WWP value. The method continues by postulating a changed value in the performance score for one or more value drivers for a selected market participant. The postulated changed value is used to determine a predicted WWP value through relative impacts of the components associated with the WWP model. Finally, a postulated market value as a function of the calculated WWP value is calculated, so as to derive a postulated change in market share associated with postulated change.

### CROSS REFERENCE TO RELATED APPLICATION(S)

This application claims priority to Australia Patent No. 2006202302, filed on May 20, 2006, which is hereby incorporated herein by reference in its entirety.

### FIELD OF THE INVENTION

The present invention relates to the analysis of market research data in order to improve the predictive power of that analysis.

### BACKGROUND OF THE INVENTION

Many organisation conduct market research in order to better understand the needs and experiences of customers in a particular market.

It is widely recognized that one of the main determinants of business profitability is market share (Buzzell, Gale and Sultan, 1975; Geurts and Whitlark, 92-93). Studies have documented those enterprises that have achieved a high level of market share within the market sectors in which they compete are more profitable than their smaller-share rivals (Buzzell et al, 1975; Gale, 1994). Traditionally, most market share strategies have focused around areas such as pricing, quality, customer satisfaction, new product introductions and added marketing programs. However, research has demonstrated that these approaches have failed to adequately explain why customers choose one product or service over another (Gale, 1994).

Bradley Gale (1994) discovered that a better explanation for customer choice was provided by the concept of customer value. Customer value is defined as quality offered at the right price based upon how the customer defines quality and price (Gale, 1994). This shift of focus on to the customer revealed that customers made their choices based upon who they perceived had the best value product offering in the market. This ultimately determined future market gains or losses for companies as it was predicted that companies that offered superior value were the ones that would be positioned to obtain gains in market share and vice versa.

This conceptual approach was further developed by Gale (1994; 2002) and customer value analysis (CVA) became a powerful strategy tool for organizations to develop share gaining strategies. CVA was taken a step further by Gale (2002) through the development of software called Digital War Room (DWR). DWR consisted of an integrated set of computerized tools to assist a management team to analyse and improve the value of their products to customers. However a question that CVA and DWR are unable to answer is “how much will the market share increase by?”.

The typical output of a CVA project is a dataset, which can be analysed using regression analysis or other similar processes to obtain a function explaining value having various weightings for each driver of customer value. Those drivers having the largest weighting are indicated by the function as those with the most impact on the perception of value. These provide guidance about targeting marketing and product development.

Whilst CVA is a very useful and effective process, as it predicts the most important drivers, it is not able to predict the expected change in market share that would result from a company taking heed of the analysis and improving its rating in one of the identified drivers. In a practical sense, whilst it may be of assistance to know what the most important drivers are, the ability to alter each driver may differ wildly in practicality and cost. Moreover, the decision maker would appreciate some guidance as to the expected change in market share which will result from a proposed investment to change a particular driver.

It is an object of the present invention to provide an improved method of market analysis which is capable of taking quantitative research data and making projections about expected changes in market share should certain identified drivers be modified.

### SUMMARY OF THE INVENTION

In a broad form, the present invention takes the drivers which have been identified through CVA or a similar process. For each driver, and for postulated changes in the values of that driver, the present invention using conjoint analysis based algorithms is able to produce postulated changes in market shares.

According to one aspect, the present invention provides a method of predicting changes in market share, in the form of Preference Shares, in a market associated with proposed performance changes, the method including at least the steps of:

providing a set of market research data suitable for CVA, including current market share data;

performing a CVA analysis through regression analysis, so that for the market as a whole, a set of coefficients determining relative importance of each value driver to WWP, and for each market participant, a set of performance scores for each value driver, and an overall WWP value;

postulating a change in the performance score for one or more value drivers for a selected market participant;

using the postulated changed value to determine a predicted WWP value through relative impacts of the components associated with the WWP model; and

calculating a postulated market value as a function of the calculated WWP value, associated with the postulated change in market share.

Accordingly, using the approach of embodiments of the present invention, it is possible to obtain data indicative of changes in market share in response to postulated changes in specific value drivers. In a preferred form, the method further takes into account the costs of such changes, the value of the increased market share, and other parameters to determine postulated financial outcome parameters for the proposed investments in changing value drivers.

The present invention further contemplates a software product adapted to operatively implement the method of the present invention.

### BRIEF DESCRIPTION OF THE DRAWINGS

An implementation of the present invention will now be described with reference to the accompanying figures, in which:

FIG. 1 illustrates a prior art theoretical model of CVA;

FIG. 2 illustrates an example of a value map; and

FIG. 3 illustrates relative importance of performance attributes to WWP.

### DESCRIPTION OF PREFERRED EMBODIMENT

The present invention will be described in more detail with reference to a specific implementation of the present invention. It will be appreciated that whilst the invention will be mainly described with reference to this specific implementation, the present invention is at a conceptual level and can be implemented in various equivalent ways, and is not limited in scope to this implementation, as will be apparent to those skilled in the art.

CVA focuses on how people choose among competing suppliers. The bases on which these choices are made often require companies to formulate strategies around three key questions (Gale, 2002):
(1) What are the key factors that customers value when they choose among suppliers or businesses and their toughest competitors?
(2) How do customers rate their suppliers' performance versus competitors on each key buying factor?
(3) What is the percentage importance of each of these components of customer value?

The identification of these key buying attributes, the tracking of the relative performance of the companies on these key attributes, and the determination of the relative importance of these attributes allows the organization to allocate resources to targeted areas where return on investment is maximized.

In a preferred form, CVA analyses are based upon a hybrid approach that involves the explicit measurement of brand and performance. Both experience and perception scores of customers and non-customers are collected as this method allows for the perceived relative value of alternative market offerings to be measured. This is an important aspect of the CVA methodological implementation, as CVA is based on the expectation that customers will make buying decisions based on the perceived relative value of market offerings. Therefore the two main dimensions in CVA relates to the tracking of perceived benefits delivered (quality dimension) and the perceived cost of acquiring benefits (price dimension).

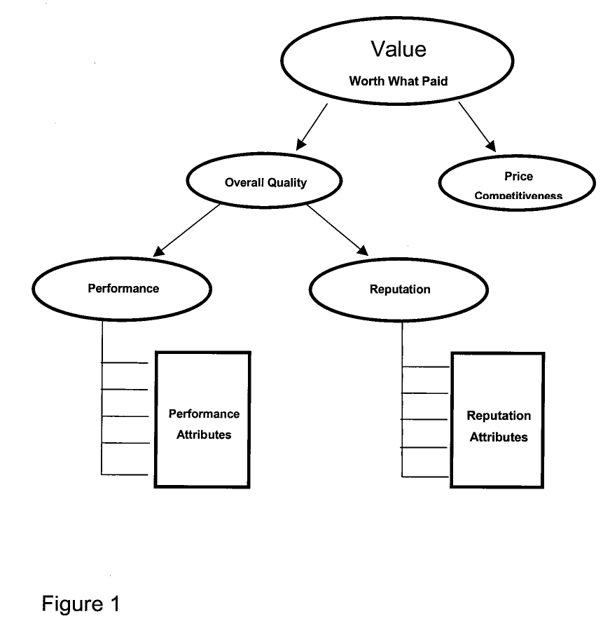

The quality dimension is measured through two separate components, performance and reputation. The other dimension that encompasses CVA would be the perceived relative price of acquiring the benefits (measured through performance and reputation). Collectively, both quality and price determines the overall value or ‘worth what paid’ (WWP) delivered by an organization. This theoretical model (WWP model) is illustrated in FIG. 1.

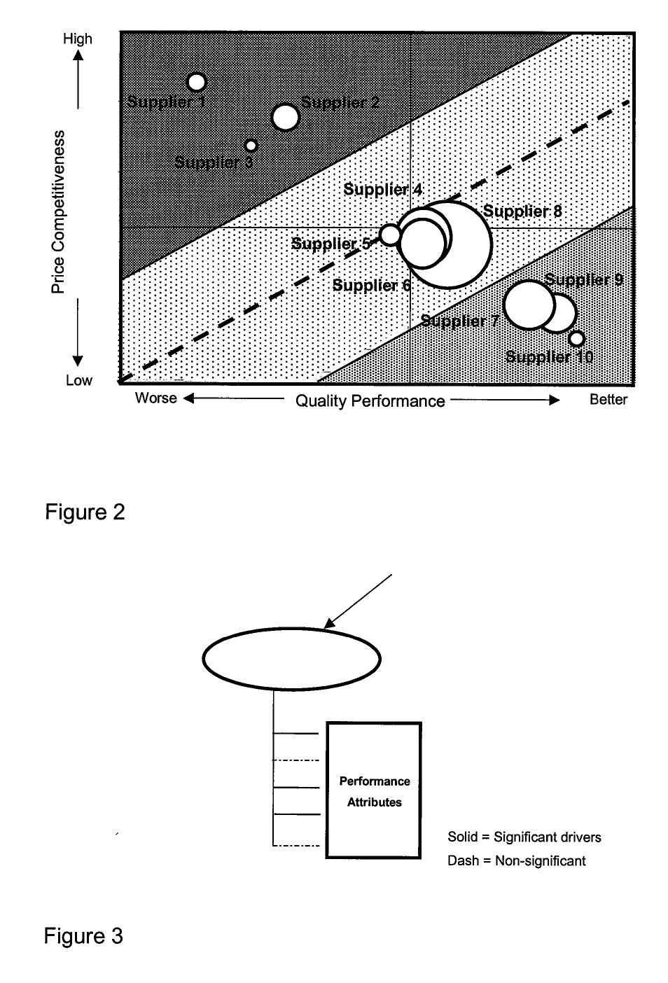

CVA outcomes can conveniently be presented in a value map where the relative market positions of all competing brands are presented in a graphical format. FIG. 2 illustrates such a value map. The Fair Value Line (the dotted line) acts as the centre point with low value on one side and high value on the other. It is the comparison of the importance of Price Competitiveness versus Quality that the market rates as fair value. The top left section (darkest shaded) indicates a market share declining position, where the price competitiveness is high relative to quality. The central portion, around the fair value line, indicates a brand in equilibrium. The lower right section indicates a brand in a market share gaining position—that is, where quality is perceived as high, relative to price. The value map identifies both the best performing brands and the worst performers in the market and concurrently also identifies the relative strengths and weaknesses of each brand. It also enables organisations to determine the value propositions of each competitor in the market, thus providing the organisation with a sense of how its market position can be altered to move into a share gaining position or how to maintain a premium market position.

Through CVA, it is possible to suggest hypothetical shifts into better value positions by changing the performance of significant attributes that are found to be driving value. From these hypothetical shifts, it is possible to estimate the extent of change needed to be made to get them to the best value position. However, it is not possible to demonstrate the influence these changes will have on their market share. Such changes in performance scores to improve value position would have consequential effect on Market Share.

The drivers of value can be identified through multiple linear regression modelling. Multiple linear regression is a statistical technique that allows for the assessment of the relationship between one dependent variable and several independent variables (Tabachnick & Fidell, 2001). Multiple regression uses several independent variables to predict a value on the dependent variable.

The result of the regression is an equation that represents the best prediction of a dependent variable of a dependent variable from several continuous independent variables (Tabachnick & Fidell, 2001). The resulting equation from the regression analysis is illustrated below:
Y′=A+B₁X₁+B₂X₂+ . . . +BₖXₖ
where Y′ is the predicted value on the dependent variable, A is the Y intercept (the value of Y when all the X values are zero), the Xs represent the various independent variables (of which there are k variables), and the Bs are the coefficients assigned to each of the independent variables during regression. Although the same intercept and coefficients are used to predict the values on the dependent variables for all cases in the sample, a different Y′value is predicted for each subject as a result of inserting the subject's own X values into the equation. The goal of regression is to arrive at the set of B values (also called regression coefficients) for the independent variables that best predicts the Y values. Both the unstandardised and standardised Beta are obtained. The importance which all the independent variables have in predicting the outcome of the dependent variable can be derived from the Pearson product-moment correlation coefficient, more commonly known as the R².

Stepwise (statistical) regression is the specific regression methodology that is preferred. This approach adopts a decision rule where only the variables that are statistically significant are included in the model. The entry level for inclusion is normally set at either the 0.05 or 0.10 significance level. In addition to this, it is preferred that the approach also sets stringent conditions for minimum R² values and multicollinearity. For instance, in order for a regression solution to be accepted, the model is required to have a minimum R² value of 70% and to be cleared of any multicollinearity issues.

At each stage of the WWP Model (also mentioned as the CVA theoretical model in FIG. 1), a separate regression analysis is performed. This approach enables the answers to the two of the three key CVA questions can obtained.

The stepwise regressions analysis performed at each step of the WWP model allows for the identification of significant variables that ultimately drive WWP. For example, a linear regression performed on the performance attributes identifies the subset of performance attributes identifying that significantly predicts WWP.

The relative importance or the impact each value attribute has on WWP can be determined from the standardized Beta that is obtained from the regression analysis. The standardized Beta is used to calculate the relative impact of all drivers across the different stages of the model. Consequently, the relative impact of Overall Quality and Price to Overall Value (WWP) can be determined.

As mentioned in the above, hypothetical shifts using DWR into better value positions are possible by changing the performance of significant attributes that are found to be driving value. However, it is not able to demonstrate the influence these changes will have on market share. The present invention accomplishes this by using theoretical concepts from Conjoint Analysis and taking advantage of other statistical parameters obtained from the linear regression to predict changes in Market Share in the form of Preference Share.

Conjoint Analysis, also known as trade-off analysis, is a quantitative research technique used to forecast market share in the form of preference share. It is used to understand consumers' preferences and the value placed on various product attributes in their purchase decision-making, particularly for a new product. Consequently, conjoint analysis has been widely used in marketing research (Roberts Research Group, 2005a & b, Gaeth, Cunningham, Chakraborty, & Juang, 1999; Gates, McDaniel, & Braunberger, 2000; Oppewal, & Timmermans, 1999).

From consumers' choice preferences, the conjoint market simulator is able to estimate the preference share of products in a competitive environment. It estimates the percent of consumer choice which specific product profiles are likely to be achieving in the competitive market. The product profiles are made up of several different combinations of product characteristics, and each characteristic has a number of levels (e.g. Colour: Red, Blue, Green). From conjoint analysis, the value (or utility) customers place on each level of each product characteristic in the experimental design is determined. The logit model is often used for conjoint analysis (Sawtooth Software, 1999, Geurts and Whitlark, 1993; Malhotra, 1984), using the statistical method multinomial logistic regression. The total utility value of a product is the sum of all the value placed on each level of each product characteristic making up that profile. The preference share of a product is obtained by dividing the value of the product by the sum for all other products in the competitive environment. Often, the logit utility requires transformation. In this case, the exponent of the utilities is used (Sawtooth Software, 1999). This method of transformation for conjoint simulation is extensively used for the Logit Model and a similar concept is used for the BTL choice model (Bradley-Terry-Luce).

For example, assume the utility for Product A=2 and the utility for Product B=3. Then the estimated preference share for Product A is ⅖=40%, and the estimated preference share for Product B is ⅗=60%. If Product A was to change and have another product feature, the new utility for Product A=4. Then the new preference share for Product A and B would be 57% and 43% respectively. Changing the product features of Product A has increased its choice potential and hence, its preference share relative to product B.

The usefulness of the conjoint simulator for forecasting Market Share has been widely documented (Sawtooth Software, 1999, Geurts and Whitlark, 1993, Roberts Research Group, 2005a & b, Gaeth et al., 1999). The power of the simulation is the ability to estimate preference share of different combination of product characteristics within the experimental design. Consequently, conjoint analysis has great commercial value, particularly in evaluating existing products and forecasting Market Share of new products.

To forecast Preference Share, the conjoint simulator compares the total value of competing products. The present invention takes this idea from Conjoint Market simulation and applies it to the quite distinct field of the WWP model.

In order to predict changes in Market Share from the changes in performance of significant value drivers, the relative impact of such effect on WWP needs to be determined. Like the total utility value of competing products in Conjoint Analysis, the relative changes in WWP of competing suppliers is associated with relative changes in Market Share.

The relative changes in WWP can be determined by calculating the predicted WWP score from the direct result of changes in performance scores of significant Value drivers. Although customers and non-customers' WWP score is measured, hypothetical changes in WWP due to changes in Value Drivers can be ascertained from Regression Analysis.

As introduced previously, the resulting equation from the regression analysis is:
Y′=A+B₁X₁+B₂X₂+ . . . +BₖXₖ
Where
Y′=Predicted dependent variable
A=Constant
B=Regression Co-efficient (Unstandarised)
X=Independent variable

The associated regression co-efficient for each significant Value driver and the constant for that stage in the WWP model is routinely obtained for CVA. Additionally, for any given performance Value mean, the value of the Dependent variable can be calculated. Note that the unstandarised B is used to calculate the predicted Y value, according to the linear regression equation (Tabachnick & Fidell, 2001).

The relative change in WWP is obtained by comparing the predicted WWP calculated from the original performance means of Values drivers with those from the hypothetical performance changes. This relative change in WWP can then be applied to the original Market Share figures to obtain the hypothetical change in Preference Share.

Consequently, in addition to the recommended changes in the performance of significant attributes that are found to be driving value into better value positions, the associated relative changes to Market Share can be simulated.

In a further refinement, preferred implementations of the present invention allow for the postulated changes in drivers and market share, and other parameters as will be described, to be processed in a financial model to determine financial parameters such a NPV and ROI of the investment in performance required to generate the postulated driver change. This allows the financial viability of the investment to be assessed in advance.

Increasing the performance of any driver of value will require an organisation to invest resources to bring about that change. This investment can take several forms, for example increased expenditure on advertising and promotions, training and development costs, or process improvements costs. The type and magnitude of the investment involved would be dependent on the set of drivers of value that is selected for improvement, that is what growth strategy is picked, and the extent of change in those drivers which is required.

According to this implementation, the method of assessing the financial viability of a project used is known commonly in financial and accounting literature as Net Present Value (NPV). The NPV of a project or investment is defined as the sum of the present values of the annual cash flows minus the initial investment (Ross, Westerfield, Bradford, 1995; Kaen, 1995). In determining NPV, this implementation requires seven major financial components. The definitions of each of the seven major components are outlined below:

(a) Cost of Capital (WACC)

The cost of capital or weighted average cost of capital (WACC) is the average cost of funds (cost of debt and cost of equity) weighted by the proportion of the funds. It reflects the risk of the business. The WACC is the rate that is used to discount future cash flows to the present to calculate a today dollar value equivalent. However, there are two sub options that can be used in determining WACC. One option is whether inflation is to be applied to cash flows and the second option is whether tax is to be incorporated in the cash flows. The implementation preferably has the flexibility to offer these options to the user and will match the WACC with the appropriate cash flows to determine a realistic (and correct) valuation.

(b) Initial Investment

This is the initial cost (today) to the business in implementing changes that result in increases in market share. The monetary value of these set up costs includes advertising, communications, training, new product developments, etc.

(c) Cash Inflows

This is the expected gain in revenue from an estimated increase in market share. The expected cash inflow is also dependent on whether a price strategy has been selected. For instance, if the organisation has decided to increase its performance on price competitiveness (that is lowering selling prices per unit), this will have an overall impact on revenue gains. This reduction in price needs to be estimated as a percentage change in the original price. This percentage change may be applicable to all of the existing business or to newly acquired business only and the implementation preferably has options that allow for this.

(d) Annual Costs

The annual costs are the ongoing costs required to sustain the increased market share resulting from the initial investment.

(e) Project Life

The project life is the period over which the increase in market share will generate benefits.

(f) Worth of Percent Gain

The monetary value in contribution to the bottom line of the business for a one percent gain in market share. It represents the net of revenue and variable costs for the products/services being analysed. For example, if revenue is $100,000 and variable costs are $40,000 and market share is 5%, then worth of percent gain is ($100,000−$40,000)/5=$12,000. This is the key component that links the financial implementation with return on investment. The estimated changes in market share will have an impact on an organisation's revenue. Any gains or losses in market share will be reflected in the organisation's earnings. Therefore the input required at this juncture is the estimated net worth (in dollar terms) of a one percent gain/loss in market share. Once this information is entered, the Prophecy® Dashboard automatically calculates a total gain/loss in revenue based on the estimated changes in market share.

(g) Ramp-Up Period

This is the time taken to achieve the full benefit of the increase in market share. For example, a campaign designed to obtain an improvement in the market perception of a brand may take one to two years to obtain the benefits.

Once the inputs of these seven major components have been filled, the NPV component of the implementation can in a preferred form produce three outputs that will determine the financial viability of the project. The first output is the NPV, which is the increase in the value in the business today after considering all relevant cash flows, the timing of the cash flows and the risk in generating the cash flows. This figure has to be a positive figure before the project can be accepted. In addition, a second condition also has to be met before a project can be accepted, that is the IRR condition. The IRR (Internal Rate of Return) is a rate that can be compared with the business's WACC or required hurdle rate (if different). If the IRR is greater than the required rate of return, the investment is worthwhile. The project will also have a positive NPV as a consequence. The third output is the Payback period which refer to the period of time it takes for the cumulative incremental benefits to match the initial investment. This can be as short as 3 months or as long as 2 years, dependent on the project life stated and the amount of revenue and investment allocated.

The seven major components of the NPV template found in the preferred implementation enable organisations to assess the financial viability of alternative growth strategies. Thus, the relationship between marketing proposals and financial investment can be linked and assessed.

In a preferred form, the present invention is implemented in a software product. In preferred embodiments, this software displays the value map (see FIG. 2), allows for simulations to be made to performance scores and simultaneously reflects the impact of these simulations on changes to market share. The financial implications of making these changes and receiving returns from the gains in market share are also simultaneously reflected in the NPV display box.

Such a tool provides organisations with the ability to conduct market simulations and simultaneously receive feedback of these simulations in the form of estimated changes to market share and the financial return on the investment made. It empowers a user to perform scenario testing.

Hence, a preferred implementation of the present invention enables users to hypothetically modify specific drivers of value to simulate the resultant effect on Market Share.

Analytical Description of the Invention

A more detailed example of an implementation of the present invention will now be presented, with reference to the accompanying tables. The tables represent worksheets from a conventional spreadsheet software product, such as Microsoft Excel. It will be understood that the calculations are automated in practice using the functionality of such products.

Table 1 illustrates a worksheet for a regression model using notional data. The sheet contains the outputs from the stepwise linear regressions for each stage of the WWP model. Only significant value drivers and its parameters are noted; namely unstandardised B, constant, and standardised beta.

Each model cascades down into the model below it, so that 5 models are shown.

Referring to the area highlighted as 2, the strength or impact each significant Independent variable has in explaining the Dependent is calculated from the Standardised Beta. Moreover, the impacts from each level is relative to the model above it. The sum of all the impacts at the top-level of the model (Quality and Price onto WWP) is 100%.

In the first column of numbers, area 1 highlights some significant parameters. The top row in each model shows the constant from each model, and below that are the standardised beta values. These parameters are used for the linear equation to calculate the predicted Dependent score.

Each regression is done with strict guidelines. A final model should only have significant independent drivers, and have an R2 of at least 70%. To achieve such a model, independents that have are high in multicollinearity with other independents and/or have outliers 3SD or 2SD are removed from analysis. This is illustrated at box 2.

The figures circled as 3 are the value impacts. These are used for the DWR Maps.

The relative value from Price and Quality are calculated from the Standardized Beta). The value impacts from all the significant Price Independent attributes, and the value impacts from all the significant Quality Independent attributes (from Reputation and Performance) sum to 100%.

Tables 2A and 2B illustrates a worksheet containing the original means for each group of interest. The performance scores (means) for all the attributes in the Customer Value Analysis are segmented by the Suppliers or Groups that are tracked. These are the observed performance scores obtained. Note that some Q values (as labelled) relate to performance, some to reputation and some to price attributes.

The attributes from this data set that were identified to be significant in predicting the Dependent—that is, hypothesised to have a linear relationship, are as follows: Q1_{—}1, 1_{—}4, 1_{—}5, 1_{—}10, 1_{—}11, 2_{—}1, 2_{—}2, 2_{—}4, @-7, 3_{—}2, 3_{—}4, 3_{—}5 and 3_{—}8. It is noted that these span performance, reputation and price.

Tables 3A and 3B illustrate the calculation of predicted means. This consolidates the information collected from Table 1 and Tables 2A and 2B. The process shown in these tables is best explained as follows.

Step 1. Calculate the Predicting Overall Performance, Reputation and Price Performance Scores.

According to the hierarchy of the WWP model, the first step is to calculate the Overall Performance, Reputation and Price performance scores according to their relative regression models. The Linear Equation is used to predict the scores, using the Constant and Unstandardised B from the associated models, and the performance scores for each significant independent attribute. The performance scores are calculated from each interested Supplier or Group, as can be seen in the rows labeled on the left column as predicted performance score, predicted reputation score and predicted price score. The predicted performance scores for each group are labeled as 1.

Step 2. Calculating Overall Quality.

The calculated Overall Quality performance score comes from the relative calculated Performance and Reputation scores. The relative impact for Performance and Reputation is calculated from the Standardized Beta (see Regression Model Sheet). These are labeled as 3.

The reason for using the Relative Impact and not the parameters (unstandardised beta) from the Linear Models, is to maintain the relative contribution of Performance and Reputation onto Quality, as per the Hypothetical WWP Model.

Step 3. Calculating WWP (Worth What is Paid).

Like Overall Quality, WWP is calculated from the relative calculated Quality and Price scores. The relative impact for Quality and Price is calculated from the Standardized Beta (see Regression Model Sheet). The reason for using the Relative Impact and not the parameters (unstandardised beta) from the Linear Models, is to maintain the relative weighting of Quality and Price onto WWP, as per the Hypothetical WWP Model. Label 4 indicates the relative impact scores. The bottom two rows illustrate two methods of calculating WWP.

In upper row, the relative impact of Price plus calculated Quality equals to WWP. In the lower row, the relative impact of Performance, Reputation and Price equals to WWP. Note, the relative impact of Performance and Reputation equals Quality.

On What basis do we make the recommendations? The recommended new mean for each significant attribute is based upon the hypothesised shift that will allow the supplier or Group of interest to obtain a share gaining position. These values are shown as label 2.

The left hand value is the new hypothesized mean, with the original mean on the right. Changing means allows for alternatives to be considered, on which to base recommendations to the client. Such a recommendation may be that if they improve on a particular significant driver, then this will influence change in Market Share. The Value Impact data (table 1) indicates which attribute mean to consider changing in order to have the greatest influence on Market Share.

Table 4 illustrates a worksheet showing how the preference share can be predicted. The predicted WWP performance score for each supplier or category group is re-stated from tables 3A, 3B in the column labeled step 1. These predicted WWP scores are transformed using the exponent [exp(X)], as used in Conjoint Market Simulations, to arrive at the figures in the column labeled step 2. Relative percentage (relative %) is obtained by taking the exp(x₁)/sum[exp(x)]. This is shown at the column labeled step 3.

The following definitions may assist in interpreting the table. Original relative %=Using the original performance scores to obtain relative % (Original Model). These figures are the column headed step 3a. Model_{—}1 Relative %=Using the changed performance scores to obtain new relative % for Model_{—}1. These figures are the column headed step 3b.

The index of change is calculated from the head to head of Model_{—}1 compared to the Original Model (Model_{—}1/(divide) Original Model). This index of change is the factor for changes in Preference Share (These figures are in the column headed Step 4).

The corresponding index for each supplier is multiplied and calibrated with the original Market Share value. Calibration ensures the predicted shares equal to 100%. The results are the Estimated change in Market Share as a consequence from changes in performance scores. An indication of the degree of Preference Share change is obtained from taking the difference between the original and the newly predicted value (Difference in Preference Share).

It will be appreciated that the new estimating Market share figures can then be reimported into DWR to reflect the changes in market shares.

Step 4. Obtaining Net Present Value (NPV) from Estimated Chances in Market Share

Once the new estimated changes to market share are obtained, the next step before a financial return can be calculated is to enter information that is required to calculate NPV. For illustration purposes, the input required is laid out in Table 5.

The cost of capital or weighted average cost of capital (WACC) reflects the risk of the business. The input is in a percent (eg: 12%). This is used to work out the discounted value of the cash flow (see Table 5A, column D, row 59). There are two sub options associated with the WACC. One option is whether inflation is to be applied to cash flows and the second option is whether tax is to be incorporated in the cash flows. The inflation and tax rates are set at a default value of 2.5% for inflation and 30% for the corporate tax rate. The default values are reflective of the current economic standard but can be changed manually if required.

Depending on which options are chosen, the calculations will be drawn from the appropriate rows found in Table 5A. For instance, if the option of both taxation and inflation is chosen, the NPV calculation will be taken off row 62, which is nominal post tax cash flow. The other options are demonstrated below:

| | | |
|---|---|---|
| Nominal post tax cash flow | Tax and Inflation | Row 62, Table 5A |
| Nominal pre tax cash flow | No Tax but with | Row 61, Table 5A |
| | Inflation | |
| Real post tax cash flow | Tax but no Inflation | Row 60, Table 5A |
| Real pre tax cash flow | No Tax and Inflation | Row 59, Table 5A |

The next input would be the initial investment. This is the set up cost in dollars to the business in implementing the share gaining strategy that has been decided. The initial investment is used as a fixed cost (an outflow of cash) at Year 0 (refer to column C).

Another cost input is called the annual cost. These are ongoing costs per year required to sustain the increased market share resulting from the initial investment. This figure is in dollars (for example, $50,000 per annum). This figure is used to calculate the annual cash outflow of the life of the project (refer to Table 5A, column D, row 44).

The worth of a percent gain is an input in dollar terms that refers to the monetary contribution to the bottom line of the business for a one percent gain in market share. Once a figure is entered here, an automatic calculation is made to determine the total cash inflow for the project. This is linked with the Excess market share (refer to Table 5). Therefore if a one percent gain in market share is worth $27,000, then a total of a 3% gain in market share is worth $81,000 per annum. This figure is then used to calculate the cash inflow for each year as part of the NPV formula (refer to Table 5A, column D, row 43).

The user will also have to determine the length of the project life, which spans between 1 to 10 years. The number of years selected determines the time period used in the NPV calculations.

The last input relates to a ramp-up period (how long till steady state). The is the time taken to achieve the full benefit of the increase in market share. The maximum ramp-up period set is 24 months. Therefore the input can range between 0 to 24 months. The length of the ramp-up period determines when the full amount of cash inflow will commence.

Once all the inputs have been entered, a financial outcome is obtained and is shown through three outputs. That is, the NPV value, the IRR (internal rate of return) value and the Payback period. The NPV figure has to be a positive figure before a project can be accepted (refer to table 5A, rows 59 to 62). Secondly, the IRR percentage has to be positive and generally greater than the WACC figure. If the IRR is greater than the required rate of return, the investment is worthwhile (refer to table 5A, rows 69 to 72). The third output is the Payback period which refers to the period of time it takes for the cumulative incremental benefits to match the initial investment (refer to table 5A, rows 74 to 77). This is calculated using: cost of project or investment/(divide) annual cash inflows (for instance in table 5A, cell C46/(divide) cell E46).

Both the NPV and IRR calculations are default formulas found in Microsoft® Excel® spreadsheets, and are used commonly in financial methods. The underlying equations and techniques are well understood. This implementation has integrated these financial methodologies with customer value analysis and thus provided a way for value strategies to be assessed financially.

It will be understood that this is only one example, and that many alternative implementations are possible. It will further be understood that the present invention seeks to make predictions, but these are necessarily made in a restricted environment, subject to appropriate assumptions.

The above example operates on the following assumptions
All suppliers or groups compete equally in the market and are subject to the same market conditions (perfect information exists in the market).
Assume that the environmental conditions remain unchanged to that when the data was collected, so that the market conditions remain constant.
The market share figures for all the suppliers or groups that have been included in the regression analysis are required for calculating the final predicted change in market share: the final predicted change in market share is based on initial market share estimates.
Only the significant drivers from the value model are used to calculate the predicted values of overall value.
The simulations are calculated based on observed survey data.
Full year discounting has been implemented to arrive at a conservative estimate of the present value of the benefits
The model cannot accommodate for structural (unobserved similarities) differences between players.
Predicted changes in market share depend on the units of the scale (e.g. 0 to 10 scale. If, for example, this was transformed to a 0 to 100 scale, then the effect of 1 unit change will be different (would be much smaller)).
The choice rule associated with this implementation is the Logistic Rule.
All results have been extrapolated from the observed range of scores within the study.

It will be appreciated that the present invention may be used in conjunction with existing techniques and tools to further enhance the reporting functions. Variations and additions are expected with different implementations of the present invention, but which utilize the general inventive concepts thereof.

### REFERENCES

Buzzell, R. D., Gale, B. T., and Sultan, R. G. M., (1975). Market Share—A Key to Profitability. Harvard Business Review, January-February, pp 97-106.
Gaeth, G. J., Cunningham, M. A., Chakraborty, G., & Juang, C. (1999). Designing managed care dental benefit plans—An application of choice-based conjoint analysis. Marketing Health Sciences, (19)4, pp 39-44.
Gale, B. T., (1994). Managing Customer Value. New York: Free Press.
Gale, B. T., (2002). How Much is Your Product Really Worth?. Customer Value Inc.
Gates, R., McDaniel, C., & Braunberger, K. (2000). Modeling consumer health plan choice behaviour to improve customer value and health plan market share. Journal of Business Research, 48, pp 247-257.
Geurts, M. D, and Whitlark, D. (1993). Forecasting Market Share. The Journal of Business Forecasting Methods & Systems, Winter 1992-1993 (11) 4. pp 17-22.
Malhotra, N. K. (1984). The use of linear logit models in marketing research. Journal of Marketing Research (February), pp 20-31.
Oppewal, H. & Timmermans, H. (1999). Modeling consumer perceptions of public space in shopping centres. Environment and Behaviour, (31) 1: pp 45-65.
Roberts Research Group (2005a). Conjoint Analysis Part I—Developing new products. http://www.robertsresearch.com.au/marketvoice/article14.htm.
Roberts Research Group (2005b). Conjoint Analysis Part II—Optimum Pricing. http://www.robertsresearch.com.au/marketvoice/article14.htm.
Sawtooth Software (1999). Choice-based Conjoint (CBC) technical paper. Sawtooth Software, Inc.
Tabachnick, B. G. and Fidell, L. S. (2001). Using Multivariate Statistics (4^{th} Ed). Allyn and Bacon. M A.
Ross, S. A., Westerfield, R. W., Bradford, D. J., (1995). Fundamentals of corporate finance, 3^{rd} ed., Chicago, Irwin.

Kaen, F. R. (1995). Corporate finance: concepts and policies. Cambridge, Mass.: Blackwell Business.

TABLE 1

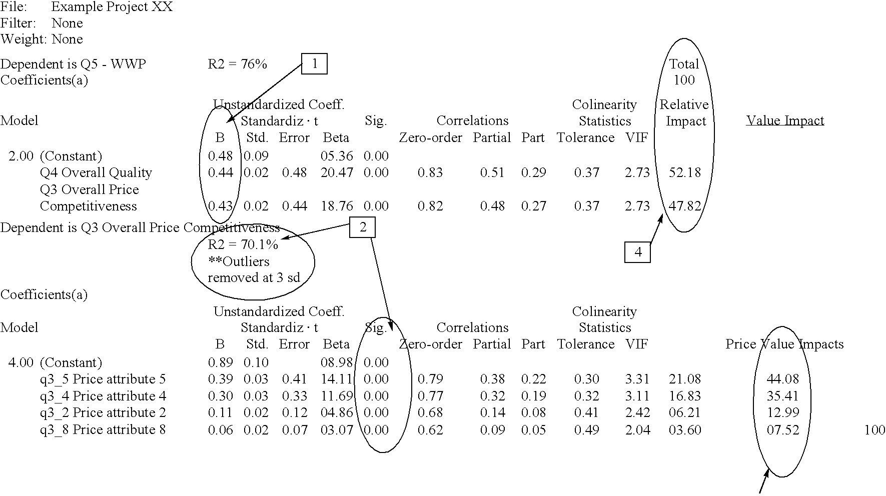

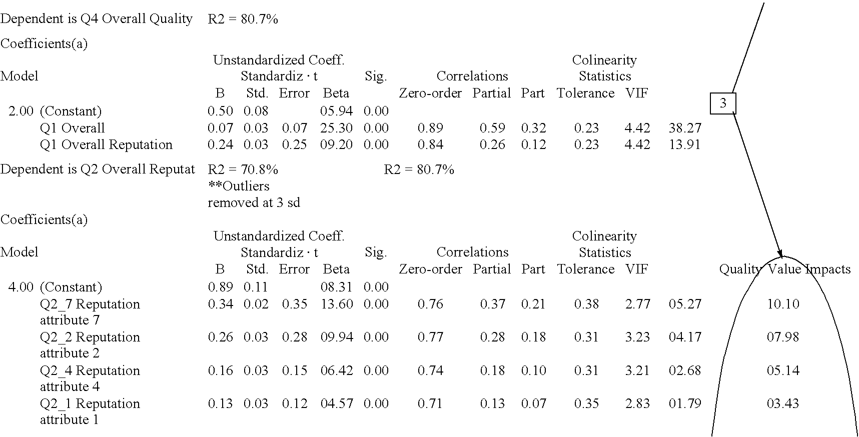

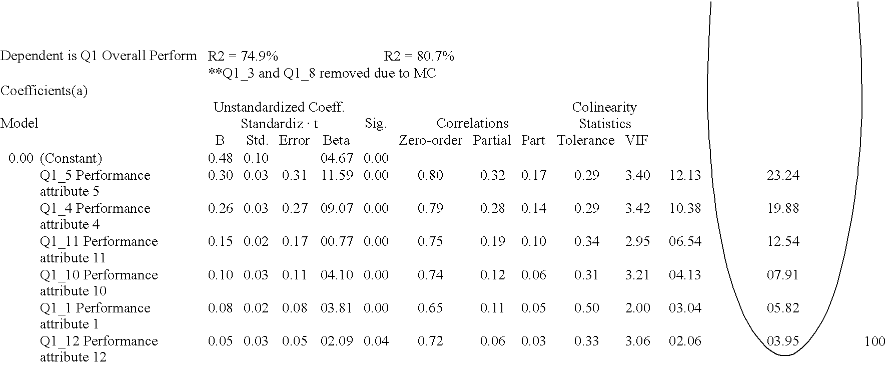

TABLE 2A
File: Example Project XX
Filter: None
Weight: None
Grped Supp - For Market Map

| | 1.00 Group A | | | | 2.00 Group B | | | |
|---|---|---|---|---|---|---|---|---|
| | | | | Standard Error | | | | Standard Error |
| Short Labels | Mean | Std Deviation | Valid N | of Mean | Mean | Std Deviation | Valid N | of Mean |
| Q1_1 Performance attribute 1 | 5.45 | 2.45 | 142.31 | 0.21 | 6.35 | 2.85 | 142.31 | 0.22 |
| Q1_2 Performance attribute 2 | 6.08 | 2.37 | 142.31 | 0.20 | 6.39 | 2.51 | 142.31 | 0.21 |
| Q1_3 Performance attribute 3 | 6.24 | 2.95 | 142.31 | 0.20 | 7.15 | 2.50 | 142.31 | 0.21 |
| Q1_4 Performance attribute 4 | 6.39 | 2.48 | 142.31 | 0.21 | 6.03 | 2.50 | 142.31 | 0.21 |
| Q1_5 Performance attribute 5 | 5.45 | 2.21 | 142.31 | 0.19 | 6.20 | 2.46 | 142.31 | 0.21 |
| Q1_6 Performance attribute 6 | 6.25 | 2.28 | 142.31 | 0.19 | 5.84 | 2.49 | 142.31 | 0.21 |
| Q1_7 Performance attribute 7 | 6.32 | 2.43 | 142.31 | 0.20 | 6.21 | 2.45 | 142.31 | 0.21 |
| Q1_8 Performance attribute 8 | 6.74 | 2.53 | 142.31 | 0.21 | 6.68 | 2.62 | 142.31 | 0.24 |
| Q1_9 Performance attribute 9 | 6.43 | 2.55 | 142.31 | 0.21 | 6.17 | 2.61 | 142.31 | 0.22 |
| Q1_10 Performance attribute 10 | 5.99 | 2.53 | 142.31 | 0.21 | 5.97 | 2.49 | 142.31 | 0.21 |
| Q1_11 Performance attribute 11 | 6.88 | 2.74 | 142.31 | 0.23 | 6.51 | 2.69 | 142.31 | 0.23 |
| Q1_12 Performance attribute 12 | 4.92 | 2.51 | 142.31 | 0.21 | 4.91 | 2.53 | 142.31 | 0.21 |
| Q2_1 Reputation attribute 1 | 6.78 | 2.65 | 142.31 | 0.22 | 5.09 | 2.79 | 142.31 | 0.23 |
| Q2_2 Reputation attribute 2 | 5.21 | 2.21 | 142.31 | 0.18 | 5.83 | 2.49 | 142.31 | 0.21 |
| Q2_4 Reputation attribute 4 | 6.03 | 2.59 | 142.31 | 0.22 | 5.76 | 2.70 | 142.31 | 0.23 |
| Q2_7 Reputation attribute 7 | 6.28 | 2.63 | 142.31 | 0.22 | 6.33 | 2.66 | 142.31 | 0.22 |
| q3_2 Price attribute 2 | 5.06 | 2.54 | 142.31 | 0.21 | 5.21 | 2.71 | 142.31 | 0.23 |
| q3_3 Price attribute 3 | 5.56 | 2.42 | 142.31 | 0.20 | 6.08 | 2.31 | 142.31 | 0.19 |
| q3_4 Price attribute 4 | 6.21 | 2.24 | 142.31 | 0.19 | 6.29 | 2.28 | 142.31 | 0.19 |
| q3_5 Price attribute 5 | 5.24 | 2.55 | 142.31 | 0.21 | 5.71 | 2.78 | 142.31 | 0.23 |
| q3_6 Price attribute 6 | 6.55 | 2.37 | 142.31 | 0.20 | 6.53 | 2.54 | 142.31 | 0.21 |
| Q2 Overall Reputation | 6.73 | 2.30 | 134.19 | 0.20 | 6.48 | 2.48 | 138.60 | 0.21 |
| Q1 Overall Performance | 6.55 | 2.04 | 130.14 | 0.18 | 6.24 | 2.52 | 138.60 | 0.21 |
| Q4 Overall Quality | 6.87 | 2.03 | 134.19 | 0.16 | 6.06 | 2.59 | 136.70 | 0.22 |
| Q3 Overall Price Competitiveness | 6.42 | 1.97 | 130.14 | 0.17 | 6.06 | 2.21 | 137.99 | 0.19 |
| Q5 WMP | 6.16 | 2.09 | 134.19 | 0.16 | 5.85 | 2.31 | 136.75 | 0.20 |
| | 3.00 Group C | | | | 4.00 Group D | | | |
| | | | | Standard Error | | | | Standard Error |
| Short Labels | Mean | Std Deviation | Valid N | of Mean | Mean | Std Deviation | Valid N | of Mean |
| Q1_1 Performance attribute 1 | 5.81 | 2.64 | 142.29 | 0.22 | 6.63 | 2.48 | 142.34 | 0.21 |
| Q1_2 Performance attribute 2 | 5.89 | 2.65 | 142.29 | 0.22 | 6.84 | 2.47 | 142.34 | 0.21 |
| Q1_3 Performance attribute 3 | 5.51 | 2.53 | 142.29 | 0.21 | 6.82 | 3.05 | 142.34 | 0.26 |
| Q1_4 Performance attribute 4 | 5.84 | 2.57 | 142.29 | 0.22 | 6.42 | 2.51 | 142.34 | 0.22 |
| Q1_5 Performance attribute 5 | 6.08 | 2.33 | 142.29 | 0.20 | 6.70 | 2.10 | 142.34 | 0.18 |
| Q1_6 Performance attribute 6 | 5.98 | 2.34 | 142.29 | 0.20 | 6.44 | 2.42 | 142.34 | 0.20 |
| Q1_7 Performance attribute 7 | 6.08 | 2.33 | 142.29 | 0.20 | 6.50 | 2.45 | 142.34 | 0.21 |
| Q1_8 Performance attribute 8 | 6.13 | 2.58 | 142.29 | 0.22 | 6.81 | 2.48 | 142.34 | 0.21 |
| Q1_9 Performance attribute 9 | 5.83 | 2.49 | 142.29 | 0.21 | 6.49 | 2.53 | 142.34 | 0.21 |
| Q1_10 Performance attribute 10 | 5.66 | 2.69 | 142.29 | 0.23 | 6.53 | 2.28 | 142.34 | 0.19 |
| Q1_11 Performance attribute 11 | 6.11 | 2.65 | 142.29 | 0.22 | 6.74 | 2.63 | 142.34 | 0.22 |
| Q1_12 Performance attribute 12 | 4.70 | 2.54 | 142.29 | 0.21 | 5.71 | 2.72 | 142.34 | 0.23 |
| Q2_1 Reputation attribute 1 | 5.88 | 2.78 | 142.29 | 0.23 | 6.52 | 2.56 | 142.34 | 0.21 |
| Q2_2 Reputation attribute 2 | 5.51 | 2.80 | 142.29 | 0.16 | 6.09 | 2.22 | 142.34 | 0.19 |
| Q2_4 Reputation attribute 4 | 5.33 | 2.62 | 142.29 | 0.22 | 6.02 | 2.59 | 142.34 | 0.22 |
| Q2_7 Reputation attribute 7 | 5.38 | 2.59 | 142.29 | 0.22 | 6.36 | 2.46 | 142.34 | 0.21 |
| q3_2 Price attribute 2 | 4.07 | 2.29 | 142.29 | 0.19 | 5.55 | 2.71 | 142.34 | 0.23 |
| q3_3 Price attribute 3 | 5.50 | 2.36 | 142.29 | 0.20 | 6.40 | 2.34 | 142.34 | 0.20 |
| q3_4 Price attribute 4 | 5.56 | 2.25 | 142.29 | 0.19 | 6.40 | 2.24 | 142.34 | 0.19 |
| q3_5 Price attribute 5 | 6.26 | 2.77 | 142.29 | 0.23 | 5.97 | 2.76 | 142.34 | 0.23 |
| q3_6 Price attribute 6 | 5.00 | 2.50 | 142.29 | 0.21 | 6.62 | 2.34 | 142.34 | 0.20 |
| Q2 Overall Reputation | 5.95 | 2.56 | 140.50 | 0.22 | 6.80 | 2.22 | 138.30 | 0.19 |
| Q1 Overall Performance | 5.82 | 2.59 | 142.29 | 0.22 | 6.63 | 2.19 | 134.29 | 0.19 |
| Q4 Overall Quality | 5.70 | 2.58 | 142.29 | 0.22 | 6.63 | 2.09 | 130.30 | 0.18 |
| Q3 Overall Price Competitiveness | 5.52 | 1.99 | 142.29 | 0.17 | 6.13 | 2.07 | 134.03 | 0.18 |
| Q5 WMP | 5.46 | 2.31 | 140.85 | 0.19 | 6.07 | 1.79 | 138.30 | 0.18 |

TABLE 2B

| 5.00 Group E | | | | 6.00 Group F | | | | 7.00 Group G | | | |
|---|---|---|---|---|---|---|---|---|---|---|---|
| | | | Standard Error | | | | Standard Error | | | | Standard Error |
| Mean | Std Deviation | Valid N | of Mean | Mean | Std Deviation | Valid N | of Mean | Mean | Std Deviation | Valid N | of Mean |
| 5.57 | 2.71 | 142.37 | 0.23 | 5.09 | 2.79 | 142.31 | 0.23 | 6.25 | 2.36 | 142.31 | 0.20 |
| 5.78 | 2.67 | 142.37 | 0.21 | 5.88 | 2.78 | 142.31 | 0.23 | 6.14 | 2.25 | 142.31 | 0.10 |
| 4.93 | 2.66 | 142.37 | 0.21 | 5.31 | 2.54 | 142.31 | 0.24 | 5.26 | 2.83 | 142.31 | 0.24 |
| 5.71 | 2.83 | 142.37 | 0.24 | 5.77 | 2.53 | 142.31 | 0.24 | 5.00 | 2.33 | 142.31 | 0.20 |
| 5.28 | 2.49 | 142.37 | 0.24 | 5.61 | 2.79 | 142.31 | 0.23 | 5.67 | 2.25 | 142.31 | 0.19 |
| 5.50 | 2.78 | 142.37 | 0.23 | 6.19 | 2.63 | 142.31 | 0.22 | 5.64 | 2.27 | 142.31 | 0.19 |
| 5.14 | 2.85 | 142.37 | 0.24 | 5.21 | 2.74 | 142.31 | 0.23 | 6.09 | 2.28 | 142.31 | 0.19 |
| 4.89 | 2.85 | 142.37 | 0.24 | 4.96 | 2.89 | 142.31 | 0.24 | 6.16 | 2.52 | 142.31 | 0.21 |
| 5.64 | 2.85 | 142.37 | 0.24 | 5.85 | 2.77 | 142.31 | 0.23 | 6.20 | 2.45 | 142.31 | 0.21 |
| 5.48 | 2.72 | 142.37 | 0.23 | 5.37 | 2.51 | 142.31 | 0.24 | 6.04 | 2.31 | 142.31 | 0.19 |
| 5.32 | 3.64 | 142.37 | 0.25 | 5.56 | 2.53 | 142.31 | 0.24 | 6.47 | 3.55 | 142.31 | 0.21 |
| 6.33 | 2.70 | 142.37 | 0.23 | 5.23 | 2.50 | 142.31 | 0.23 | 5.22 | 2.23 | 142.31 | 0.19 |
| 5.85 | 2.87 | 142.37 | 0.24 | 5.48 | 3.03 | 142.31 | 0.25 | 6.40 | 2.50 | 142.31 | 0.21 |
| 4.85 | 2.54 | 142.37 | 0.21 | 5.45 | 2.69 | 142.31 | 0.23 | 5.82 | 2.10 | 142.31 | 0.18 |
| 5.37 | 2.73 | 142.37 | 0.23 | 5.42 | 2.77 | 142.31 | 0.23 | 5.88 | 2.45 | 142.31 | 0.21 |
| 5.63 | 2.58 | 142.37 | 0.25 | 5.59 | 3.01 | 142.31 | 0.25 | 6.21 | 2.35 | 142.31 | 0.20 |
| 5.68 | 2.74 | 142.37 | 0.23 | 4.73 | 2.69 | 142.31 | 0.23 | 5.28 | 2.34 | 142.31 | 0.20 |
| 5.29 | 2.77 | 142.37 | 0.23 | 5.20 | 2.51 | 142.31 | 0.22 | 5.99 | 2.39 | 142.31 | 0.20 |
| 5.49 | 2.71 | 142.37 | 0.23 | 5.11 | 2.67 | 142.31 | 0.22 | 6.03 | 2.19 | 142.31 | 0.18 |
| 5.16 | 2.59 | 142.37 | 0.23 | 5.23 | 2.55 | 142.31 | 0.24 | 5.56 | 2.52 | 142.31 | 0.21 |
| 5.54 | 2.80 | 142.37 | 0.24 | 5.77 | 2.50 | 142.31 | 0.23 | 6.20 | 2.12 | 142.31 | 0.18 |
| 5.84 | 2.83 | 133.16 | 0.25 | 5.65 | 2.65 | 138.00 | 0.25 | 6.40 | 2.35 | 135.52 | 0.20 |
| 5.92 | 2.87 | 133.16 | 0.25 | 5.78 | 2.55 | 140.76 | 0.24 | 6.36 | 2.34 | 133.45 | 0.20 |
| 5.50 | 2.78 | 130.65 | 0.24 | 5.56 | 2.51 | 143.75 | 0.24 | 6.35 | 2.32 | 134.54 | 0.20 |
| 5.41 | 2.61 | 133.16 | 0.23 | 5.09 | 2.51 | 135.13 | 0.24 | 5.94 | 2.33 | 135.77 | 0.20 |
| 5.45 | 2.41 | 133.16 | 0.21 | 5.23 | 2.69 | 139.22 | 0.23 | 5.77 | 2.28 | 132.13 | 0.20 |

| 8.00 Group H | | | | 10.00 Group I | | | |
|---|---|---|---|---|---|---|---|
| | | | Standard Error | | | | Standard Error |
| Mean | Std Deviation | Valid N | of Mean | Mean | Std Deviation | Valid N | of Mean |
| 5.25 | 2.65 | 142.25 | 0.24 | 5.24 | 2.74 | 142.34 | 0.23 |
| 5.46 | 2.87 | 142.25 | 0.24 | 5.40 | 2.64 | 142.34 | 0.22 |
| 4.09 | 2.68 | 142.25 | 0.23 | 5.54 | 3.05 | 142.34 | 0.26 |
| 5.11 | 2.79 | 142.24 | 0.23 | 5.44 | 2.63 | 142.34 | 0.24 |
| 4.76 | 2.82 | 142.28 | 0.24 | 5.04 | 2.63 | 142.34 | 0.22 |
| 4.58 | 2.76 | 142.28 | 0.23 | 5.82 | 2.82 | 142.34 | 0.24 |
| 5.03 | 2.77 | 142.28 | 0.23 | 6.10 | 2.83 | 142.34 | 0.24 |
| 4.72 | 2.83 | 142.28 | 0.24 | 3.87 | 2.76 | 142.34 | 0.23 |
| 5.06 | 2.81 | 142.28 | 0.24 | 5.65 | 2.69 | 142.34 | 0.24 |
| 4.96 | 2.83 | 142.28 | 0.24 | 5.05 | 2.77 | 142.34 | 0.23 |
| 5.36 | 3.14 | 142.28 | 0.25 | 6.10 | 2.97 | 142.34 | 0.25 |
| 4.51 | 2.89 | 142.28 | 0.24 | 5.17 | 2.52 | 142.34 | 0.24 |
| 5.42 | 2.80 | 142.28 | 0.24 | 5.25 | 2.67 | 142.34 | 0.22 |
| 4.91 | 2.59 | 142.28 | 0.22 | 4.88 | 2.48 | 142.34 | 0.21 |
| 5.08 | 2.82 | 142.28 | 0.24 | 5.09 | 2.71 | 142.34 | 0.23 |
| 5.01 | 2.93 | 142.28 | 0.25 | 5.53 | 2.82 | 142.34 | 0.24 |
| 4.64 | 2.76 | 142.28 | 0.23 | 4.81 | 2.71 | 142.34 | 0.23 |
| 5.03 | 2.87 | 142.28 | 0.25 | 4.92 | 2.57 | 142.34 | 0.22 |
| 5.07 | 2.68 | 142.28 | 0.24 | 5.28 | 2.50 | 142.34 | 0.21 |
| 4.87 | 2.92 | 142.28 | 0.24 | 5.02 | 2.09 | 142.34 | 0.25 |
| 5.21 | 2.95 | 142.28 | 0.25 | 5.38 | 2.66 | 142.34 | 0.22 |
| 5.25 | 3.05 | 120.11 | 0.27 | 5.58 | 2.63 | 129.27 | 0.23 |
| 5.31 | 2.91 | 128.28 | 0.28 | 5.61 | 2.71 | 130.91 | 0.24 |
| 5.09 | 2.90 | 127.18 | 0.26 | 5.63 | 2.52 | 129.27 | 0.22 |
| 4.99 | 2.75 | 127.18 | 0.24 | 5.47 | 2.58 | 128.00 | 0.23 |
| 5.01 | 2.70 | 128.26 | 0.24 | 5.20 | 2.51 | 130.59 | 0.22 |

TABLE 3A
ONLY SIGNIFICANT DRIVERS

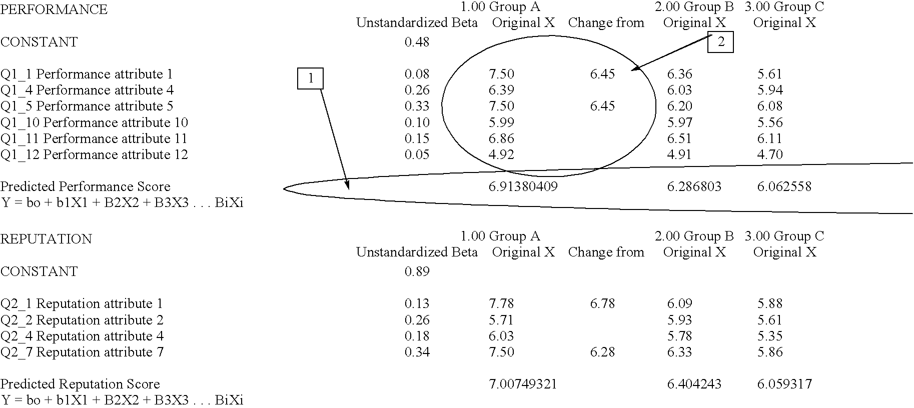

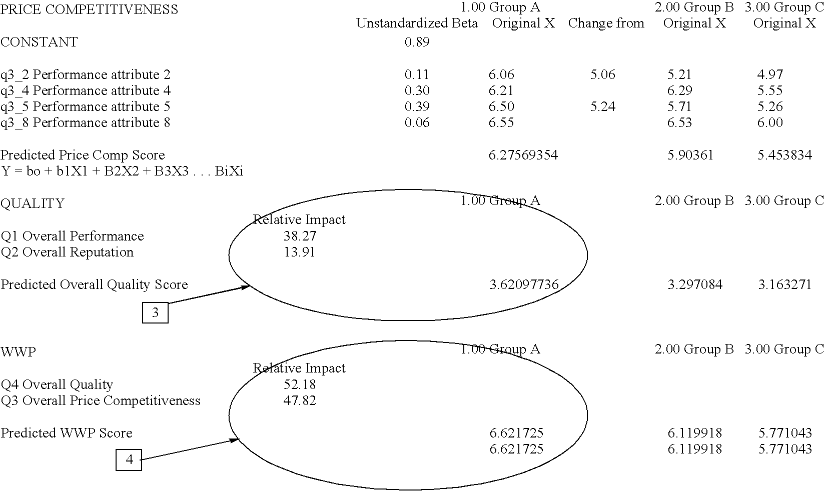

TABLE 3B

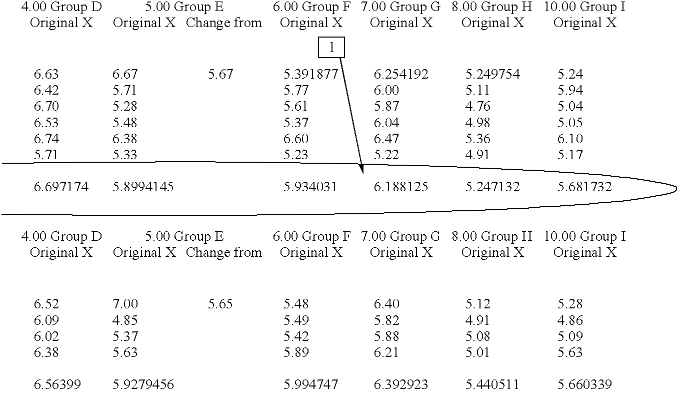

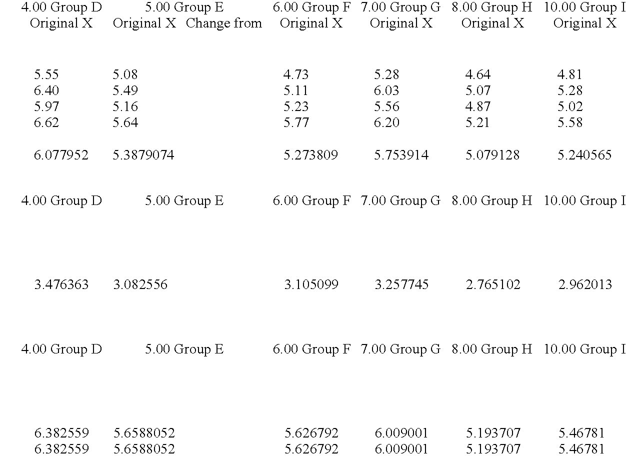

TABLE 4

| | | |
|---|---|---|
| | Step 2 | |
| Step 1 | EXP (predicted | Step 3 |
| Predicted WP | WWP mean) | Relative % |

| | | | |
|---|---|---|---|
| 1.00 Group A | 6.621725003 | 751.24 | 21.42% |
| 2.00 Group B | 5.119918225 | 454.83 | 12.97% |
| 3.00 Group C | 5.771043307 | 320.87 | 9.15% |
| 4.00 Group D | 6.382550237 | 591.44 | 16.80% |
| 5.00 Group E | 6.658805195 | 235.81 | 8.18% |
| 6.00 Group F | 5.02579156 | 277.77 | 7.92% |
| 7.00 Group G | 6.009001254 | 407.08 | 11.81% |
| 8.00 Group H | 5.183707011 | 183.14 | 5.14% |
| 10.00 Group I | 5.487809589 | 238.94 | 6.76% |
| | | 3507.11 | 100.00% |

| | | Step 3b | |
|---|---|---|---|
| | | Model_1 | Step 4 |
| | Step 3a | Relative % | Index of |
| | Original Relative % | Model_1 | Change |
| | Original Model | Revised % | H2H |
| | Predicted % from | after Mean | new/original |
| | Original means | Changes | before change |
| 1.00 Group A | 14.1% | 21.4% | 1.519 |
| 2.00 Group B | 14.3% | 13.0% | 0.910 |
| 3.00 Group C | 10.1% | 9.1% | 0.910 |
| 4.00 Group D | 18.5% | 16.9% | 0.910 |
| 5.00 Group E | 8.5% | 8.2% | 0.800 |
| 6.00 Group F | 8.7% | 7.9% | 0.910 |
| 7.00 Group G | 12.8% | 11.0% | 0.910 |
| 8.00 Group H | 5.6% | 5.1% | 0.910 |
| 10.00 Group I | 7.4% | 6.6% | 0.910 |
| | 100.0% | 100.0% | |

Estimating Change in Market Share

| | | Uncalibrated | Calibration | Difference |
|---|---|---|---|---|
| | | Estimated | Estimated | in |
| | Current | Change in | Change in | Preference |
| | MS | Market Share | Market Share | Share |
| 1.00 Group A | 4.03 | 7.03 | 7.40 | −2.83 |
| 2.00 Group B | 12.09 | 11.00 | 11.67 | −0.47 |
| 3.00 Group C | 6.67 | 5.07 | 5.32 | −0.15 |
| 4.00 Group D | 8.06 | 5.46 | 6.80 | −0.21 |
| 5.00 Group E | 0.01 | 8.64 | 0.17 | −0.37 |
| 6.00 Group F | 6.13 | 5.62 | 5.98 | −0.21 |
| 7.00 Group G | 5.75 | 6.16 | 5.54 | −0.24 |
| 8.00 Group H | 0.94 | 0.86 | 0.91 | −0.03 |
| 10.00 Group I | 11.68 | 10.61 | 11.28 | −0.45 |
| OTHER | 37.14 | 33.79 | 35.85 | −1.29 |
| Total | 100.00 | 94.26 | 100.00 | −0.00 |

TABLE 5

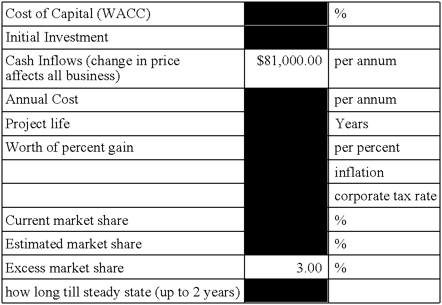

TABLE 5A

| | B | C | D | E | F | G | H |
|---|---|---|---|---|---|---|---|
| 38 | | | | | | | |
| 39 | | | | | | | |
| 40 | | | | | | | |
| 41 | | | | | | | |
| 42 | Year | 0 | 1 | 2 | 3 | 4 | 5 |
| 43 | Cash Inflow | | $81,000.00 | $81,000.00 | $81,000.00 | $81,000.00 | $81,000.00 |
| 44 | Cash outflow | $100,000.00 | $50,000.00 | $50,000.00 | $50,000.00 | $50,000.00 | $50,000.00 |
| 45 | Inflow-Outflow | $100,000.00 | $31,000.00 | $31,000.00 | $31,000.00 | $31,000.00 | $31,000.00 |
| 46 | Real pre tax CF | $100,000.00 | $31,000.00 | $31,000.00 | $31,000.00 | $31,000.00 | $31,000.00 |
| 47 | Real post tax CF | $100,000.00 | $21,700.00 | $21,700.00 | $21,700.00 | $21,700.00 | $21,700.00 |
| 48 | Nominal pre tax CF | $100,000.00 | $31,775.00 | $32,563.38 | $33,383.61 | $34,218.20 | $35,073.65 |
| 49 | Nominal post tax CF | $100,000.00 | $22,242.50 | $22,798.56 | $23,368.53 | $23,952.74 | $24,551.56 |
| 50 | | | | | | | |
| 54 | Discounted value - Real pre tax CF | $100,000.00 | $27,678.57 | $24,713.01 | $22,065.19 | $19,701.06 | $17,590.23 |
| 55 | Discounted value - Real post tax CF | $100,000.00 | $19,375.00 | $17,299.11 | $15,445.63 | $13,780.74 | $12,313.16 |
| 56 | Discounted value - Nominal pre tax C [symbol] | $100,000.00 | $28,370.54 | $26,964.11 | $23,761.79 | $21,746.28 | $19,801.76 |
| 57 | Discounted value - Nominal post tax [symbol] | $100,000.00 | $19,859.38 | $18,174.87 | $16,633.26 | $15,222.40 | $13,931.21 |
| 58 | | | | | | | |
| 59 | NPV - Real pre tax CF | | −$72,321.43 | −$47,608.42 | −$25,543.23 | −$5,842.17 | $11,748.06 |
| 60 | NPV - Real post tax CF | | −$80,625.00 | −$63,325.89 | −$47,880.26 | −$34,089.52 | −$21,776.36 |
| 61 | NPV - Nominal pre tax CF | | −$71,629.46 | −$45,665.36 | −$21,903.56 | −$157.28 | $19,744.45 |
| 62 | NPV - Nominal post tax CF | | −$80,140.63 | −$61,965.75 | −$45,332.49 | −$30,110.10 | −$16,178.33 |
| 63 | | | | | | | |
| 68 | | | | | | | |
| 69 | IRR - Real pre tax CF | | #NUM! | −26.71% | −3.54% | 9.20% | 16.84% |
| 70 | IRR - Real post tax CF | | #NUM! | −41.32% | −18.74% | −5.43% | 2.78% |
| 71 | IRR - Nominal pre tax CF | | #NUM! | −24.87% | −1.13% | 11.93% | 19.56% |
| 72 | IRR - Nominal post tax CF | | #NUM! | −39.85% | −6.70% | −3.07% | 5.35% |
| 73 | | | | | | | |
| 74 | Payback - Real pre tax CF (years) | | 3.23 | 3.23 | 3.23 | 3.23 | 3.23 |
| 75 | Payback - Real post tax CF (years) | | 4.61 | 4.61 | 4.61 | 4.61 | 4.61 |
| 76 | Payback - Nominal pre tax CF (years) | | 3.15 | 3.07 | 3.00 | 2.82 | 2.85 |
| 77 | Payback - Nominal post tax CF (years) | | 4.50 | 4.39 | 4.28 | 4.17 | 4.07 |
| 78 | | | | | | | |
| 82 | | | | | | | |
| 83 | DECISION | | | | | | |

| | B | I | J | K | L | M |
|---|---|---|---|---|---|---|
| 38 | | | | | | |
| 39 | | | | | | |
| 40 | | | | | | |
| 41 | | | | | | |
| 42 | Year | 6 | 7 | 8 | 9 | 10 |
| 43 | Cash Inflow | $81,000.00 | $81,000.00 | $81,000.00 | $81,000.00 | $81,000.00 |
| 44 | Cash outflow | $50,000.00 | $50,000.00 | $50,000.00 | $50,000.00 | $50,000.00 |
| 45 | Inflow-Outflow | $31,000.00 | $31,000.00 | $31,000.00 | $31,000.00 | $31,000.00 |
| 46 | Real pre tax CF | $31,000.00 | $31,000.00 | $31,000.00 | $31,000.00 | $31,000.00 |
| 47 | Real post tax CF | $21,700.00 | $21,700.00 | $21,700.00 | $21,700.00 | $21,700.00 |
| 48 | Nominal pre tax CF | $35,950.50 | $38,849.26 | $37,770.49 | $38,714.75 | $39,682.62 |
| 49 | Nominal post tax CF | $26,165.35 | $26,794.48 | $26,439.34 | $27,100.33 | $27,777.83 |
| 50 | | | | | | |
| 54 | Discounted value - Real pre tax CF | $16,705.56 | $14,022.83 | $12,520.38 | $11,178.91 | $9,981.17 |
| 55 | Discounted value - Real post tax CF | $10,993.90 | $9,815.98 | $8,764.27 | $7,825.24 | $6,986.82 |
| 56 | Discounted value - Nominal pre tax C [symbol] | $18,213.64 | $16,669.73 | $15,254.87 | $13,960.93 | $12,776.74 |
| 57 | Discounted value - Nominal post tax [symbol] | $12,749.55 | $11,668.11 | $10,678.41 | $9,772.65 | $8,943.72 |
| 58 | | | | | | |
| 59 | NPV - Real pre tax CF | 27,453.63 | 41,476.45 | $53,996.33 | $65,176.74 | $76,156.31 |
| 60 | NPV - Real post tax CF | −10,782.46 | −966.48 | $7,797.78 | $15,623.02 | $22,609.84 |
| 61 | NPV - Nominal pre tax CF | 37,358.09 | 54,626.83 | $69,881.69 | $83,842.62 | $96,619.36 |
| 62 | NPV - Nominal post tax CF | −3,429.33 | 8,238.78 | $18,917.19 | $28,689.84 | $37,623.55 |
| 63 | | | | | | |
| 68 | | | | | | |
| 69 | IRR - Real pre tax CF | 21.24% | 24.20% | 26.17% | 27.52% | 28.47% |
| 70 | IRR - Real post tax CF | 8.10% | 11.69% | 14.20% | 15.99% | 17.30% |
| 71 | IRR - Nominal pre tax CF | 24.27% | 27.30% | 29.33% | 30.71% | 31.68% |
| 72 | IRR - Nominal post tax CF | 10.81% | 14.43% | 17.05% | 13.89% | 20.23% |
| 73 | | | | | | |
| 74 | Payback - Real pre tax CF (years) | 3.23 | 3.23 | 3.23 | 3.23 | 3.23 |
| 75 | Payback - Real post tax CF (years) | 4.61 | 4.61 | 4.61 | 4.61 | 4.61 |
| 76 | Payback - Nominal pre tax CF (years) | 2.78 | 2.71 | 2.65 | 2.58 | 2.52 |
| 77 | Payback - Nominal post tax CF (years) | 3.97 | 3.88 | 3.78 | 3.69 | 3.60 |
| 78 | | | | | | |
| 82 | | | | | | |
| 83 | DECISION | | | | | ACCEPT |

What is claimed is:

1. A method of predicting changes in market share, in the form of Preference Shares, in a market associated with proposed performance changes, the method comprising:
providing a set of market research data suitable for CVA, including current market share data;
performing a CVA analysis through regression analysis in order to determine WWP parameters, so that for the market as a whole, a set of coefficients determining relative importance of each value driver to WWP, and for each market participant, a set of performance scores for each value driver, and an overall WWP value;
postulating a changed value in the performance score for one or more value drivers for a selected market participant;
using the postulated changed value to determine a predicted WWP value through relative impacts of components associated with the WWP model; and
calculating a postulated market value as a function of the calculated WWP value, so as to derive a postulated change in market share associated with postulated change.

2. A method according to claim 1, wherein the postulated changed value is one which would result according to the WWP model in obtaining a share gaining position.

3. A method according to claim 2, wherein the change in postulated market share is calculated using the exponent of the predicted WWP values for each market participant, and the existing market shares, so to derive new predicted preference shares for each market participant.

4. A method according to claim 1, wherein the postulated market value, the estimated cost of achieving the postulated changed values in performance scores, and other predetermined financial parameters, are used to calculate an estimate of financial outcomes for the postulated changed values in performance scores.

5. A software program product on a computer readable storage medium operatively adapted to implement a method according to claim 1.

6. A data processing system for predicting changes in market share, in the form of Preference Shares, in a market associated with proposed performance changes comprising:
a code component for receiving a set of market research data suitable for CVA, including current market share data;
a code component for performing a CVA analysis through regression analysis in order to determine WWP parameters, so that for the market as a whole, a set of coefficients determining relative importance of each value driver to WWP, and for each market participant, a set of performance scores for each value driver, and an overall WWP value;
a code component for postulating a changed value in the performance score for one or more value drivers for a selected market participant;
a code component for using the postulated changed value to determine a predicted WWP value through relative impacts of components associated with the WWP model; and
a code component for calculating a postulated market value as a function of the calculated WWP value, so as to derive a postulated change in market share associated with postulated change.

7. A system according to claim 6, wherein the postulated changed value is one which would result according to the WWP model in obtaining a share gaining position.

8. A system according to claim 6, wherein the change in postulated market share is calculated using the exponent of the predicted WWP values for each market participant, and the existing market shares, so to derive new predicted preference shares for each market participant.

9. A system according to claim 6, wherein the postulated market value, the estimated cost of achieving the postulated changed values in performance scores, and other predetermined financial parameters, are used to calculate an estimate of financial outcomes for the postulated changed values in performance scores.
